(19) United States
(12) Patent Application Publication
(10) Pub. No.: US 2026/0306356 A1
(43) Pub. Date: Oct. 8, 2026

(54) SWINGING MECHANISM AND ADULT MASSAGER

(71) Applicant: Liang CHEN, Shenzhen (CN)

(72) Inventor: Liang CHEN, Shenzhen (CN)

(21) Appl. No.: 19/172,510

(22) Filed: Apr. 7, 2025

(51) Int. Cl. A61H 23/02; A61H 19/00

(52) U.S. Cl. CPC A61H 23/0254; A61H 19/30; A61H 19/44; A61H 2201/1215; A61H 2201/149; A61H 2201/1676; A61H 2205/087

(57) ABSTRACT

The present invention discloses a swinging mechanism and an adult massager. The swinging mechanism includes: a support member; a driving assembly, disposed on the support member; and a swinging member, rotatably disposed on the support member through a rotating shaft and being in transmission connection with the driving assembly, where the driving assembly drives the swinging member to perform a longitudinal or transverse swinging operation on the support member. According to the present invention, the swinging member is driven to perform the longitudinal or transverse swinging operation through the driving assembly, thereby improving use experience of a user and effectively solving a problem that an existing adult massager has a relatively single function.

### TECHNICAL FIELD

The present invention relates to the technical field of massagers, and in particular, to a swinging mechanism and an adult massager.

### BACKGROUND

With the development of economy and the progress of society, the heavy and busy fast pace makes men's working pressure greater, and therefore, alleviating daily working pressure has become a necessity and a social consensus. Various electric appliances are increasingly developing in the direction of alleviating working pressure, being convenient to use, being safe and efficient, etc., and an adult massager, as an important member of the electric appliances in people's lives, is no exception. At present, existing adult massagers generally use a motor to drive a telescopic mechanism for telescopic operation and a vibration motor to generate vibration for massage operation. Such adult massagers have a relatively single function and cannot meet the needs of users. Therefore, a swinging mechanism and an adult massager are provided to solve the above problems.

### SUMMARY

One of the purposes of the present invention is to provide a swinging mechanism and an adult massager, so as to solve a problem that an existing adult massager has a relatively single function.

The swinging mechanism and the adult massager of the present invention may be implemented through the following technical solutions:

A swinging mechanism of the present invention is applied to an adult massager and includes: a support member; a driving assembly, disposed on the support member; and a swinging member, rotatably disposed on the support member through a rotating shaft and being in transmission connection with the driving assembly, where the driving assembly drives the swinging member to perform a longitudinal or transverse swinging operation on the support member.

In an implementation, the support member includes a fixing cavity and a mounting base that are fixedly connected; the driving assembly is movably disposed on the fixing cavity in a penetrating manner; and the swinging member is rotatably disposed on the mounting base through the rotating shaft and is in transmission connection with the driving assembly.

In an implementation, the fixing cavity is provided with a plurality of fixing holes in a penetrating manner, and the support member is fixedly mounted in the adult massager through the plurality of fixing holes.

In an implementation, the fixing cavity is provided with a through hole in a penetrating manner, and the driving assembly movably penetrates through the fixing cavity through the through hole.

In an implementation, an articulated head is disposed on the mounting base, and the swinging member is rotatably disposed on the articulated head through the rotating shaft.

In an implementation, the driving assembly includes a driving motor and an eccentric connecting member that are in transmission connection; the driving motor is fixedly disposed in the fixing cavity, and an output shaft of the driving motor movably penetrates through the fixing cavity; and two ends of the eccentric connecting member are in transmission connection with the driving motor and the swinging member respectively.

In an implementation, the eccentric connecting member includes a connecting shaft and an eccentric head; the connecting shaft is fixedly connected to the output shaft of the driving motor; and the eccentric head is eccentrically and fixedly disposed on one side of the connecting shaft and is in transmission connection with the swinging member.

In an implementation, the swinging member includes a connecting rod and a swinging tongue; the connecting rod is in transmission connection with the eccentric connecting member; and the swinging tongue is fixedly disposed on one side of the connecting rod and is on a same straight line as the connecting rod.

In an implementation, the swinging member includes a connecting rod and a swinging ball; the connecting rod is in transmission connection with the eccentric connecting member; and the swinging ball is fixedly disposed on the connecting rod and is disposed perpendicular to the connecting rod.

In an implementation, the swinging member includes a connecting rod, a swinging tongue, and a swinging ball; the connecting rod is in transmission connection with the eccentric connecting member; the swinging tongue is fixedly disposed on one side of the connecting rod and is on a same straight line as the connecting rod; and the swinging ball is fixedly disposed on the connecting rod and is disposed perpendicular to the connecting rod.

In an implementation, the swinging mechanism further includes a vibration motor, and the vibration motor is fixedly disposed on the support member.

In an implementation, the support member includes a fixing cavity, a mounting base, and a motor fixing cavity that are sequentially connected, the driving assembly is movably disposed on the fixing cavity in a penetrating manner, the swinging member is rotatably disposed on the mounting base through the rotating shaft and is in transmission connection with the driving assembly, and the vibration motor is fixedly disposed in the motor fixing cavity.

An adult massager of the present invention includes: an outer housing, being a hollow cavity with an opening at one end; an accommodating cavity, made of a flexible material, where the accommodating cavity is fixedly disposed in the outer housing, and an opening direction of the accommodating cavity is consistent with an opening direction of the outer housing; a circuit board, fixedly disposed in the outer housing; at least one vibration motor, fixedly disposed in the accommodating cavity and electrically connected to the circuit board; a plurality of buttons, disposed on the circuit board respectively and penetrating through the outer housing respectively; a charging pin, fixedly disposed in the outer housing in a penetrating manner and electrically connected to the circuit board; a swinging mechanism, disposed in the outer housing and extending into the accommodating cavity, where the swinging mechanism is electrically connected to the circuit board and can perform a longitudinal swinging operation in the accommodating cavity; and a battery, fixedly mounted in the outer housing, where the battery supplies electric energy to the circuit board, the at least one vibration motor, and the swinging mechanism respectively.

In an implementation, the swinging mechanism includes: a support member, fixedly mounted in the outer housing; a driving assembly, disposed on the support member and electrically connected to the circuit board; and a swinging member, rotatably disposed on the support member through a rotating shaft, where the swinging member is in transmission connection with the driving assembly, and the swinging member extends into a swinging tongue cavity of the accommodating cavity.

In an implementation, a plurality of massaging members are disposed on an inner wall of the accommodating cavity in an integrally-formed manner.

An adult massager of the present invention includes: an inner housing, being a hollow cavity with an opening at one end; a circuit board, fixedly disposed in the inner housing; a plurality of buttons, disposed on the circuit board respectively and penetrating through the inner housing respectively; a charging pin, penetrating through the inner housing and electrically connected to the circuit board; a swinging mechanism, where one end of the swinging mechanism is fixedly disposed on the inner housing; a battery, fixedly mounted in the inner housing, where the battery supplies electric energy to the circuit board and the swinging mechanism respectively; and an outer housing, made of a flexible material, where the outer housing wraps the inner housing and the swinging mechanism respectively, and the swinging mechanism drives the outer housing to perform a transverse swinging operation.

In an implementation, the outer housing includes: an outer housing main body, being a hollow flexible sleeve body with an opening at one end, where the inner housing and the swinging mechanism are disposed in the outer housing main body respectively; and a sealing cover body, detachably connected to the opening of the outer housing main body in a sealing manner.

In an implementation, the outer housing main body is vertically provided with a protruding swinging ball cavity, and the swinging ball cavity is integrally formed with the outer housing main body.

In an implementation, the swinging mechanism includes: a support member, where one end of the support member is fixedly disposed on the inner housing; a driving assembly, disposed on the support member; a swinging member, rotatably disposed on the support member through a rotating shaft and being in transmission connection with the driving assembly, where the swinging member extends into the swinging ball cavity; and a vibration motor, fixedly disposed at a front end of the support member.

In an implementation, the swinging member includes a connecting rod and a swinging ball; the connecting rod is in transmission connection with the driving assembly; and the swinging ball is fixedly disposed on the connecting rod and is disposed perpendicular to the connecting rod.

Compared with the prior art, beneficial effects of the swinging mechanism and the adult massager of the present invention are as follows:

According to the swinging mechanism and the adult massager of the present invention, the swinging member is driven to perform the longitudinal or transverse swinging operation on the support member through the driving assembly, to implement an internal swinging function of the adult massager, thereby improving the use experience of the user and effectively solving the problem that the existing adult massager has the relatively single function. Meanwhile, the swinging mechanism and a vibration mechanism are disposed in the adult massager, to implement a plurality of massaging functions of the adult massager, thereby enhancing the user experience of the user.

### BRIEF DESCRIPTION OF THE DRAWINGS

To describe the technical solutions in the embodiments of the present invention more clearly, the following briefly describes the accompanying drawings required for describing the embodiments. It should be understood that the following accompanying drawings show merely some embodiments of the present invention, and therefore should not be regarded as a limitation on the scope. Those of ordinary skill in the art may still derive other related accompanying drawings from these accompanying drawings without creative efforts.

FIG. 1 is a schematic structural diagram of a swinging mechanism according to a first embodiment of the present invention;

FIG. 2 is a schematic structural exploded view of a swinging mechanism shown in FIG. 1 according to a first embodiment;

FIG. 3 is a schematic structural diagram of a swinging mechanism according to a second embodiment of the present invention;

FIG. 4 is a schematic structural exploded view of a swinging mechanism shown in FIG. 3 according to a second embodiment;

FIG. 5 is a schematic structural diagram of a swinging mechanism according to a third embodiment of the present invention;

FIG. 6 is a schematic structural exploded view of a swinging mechanism shown in FIG. 5 according to a third embodiment;

FIG. 7 is a schematic structural diagram of an adult massager according to a first embodiment of the present invention;

FIG. 8 is a schematic structural exploded view of an adult massager shown in FIG. 7 according to a first embodiment of the present invention;

FIG. 9 is a schematic structural diagram of an adult massager according to a second embodiment of the present invention; and

FIG. 10 is a schematic structural exploded view of an adult massager shown in FIG. 9 according to a second embodiment of the present invention.

Reference numerals in the accompanying drawings: 10. first swinging mechanism; 11. first support member; 111. first fixing cavity; 1111. fixing hole; 1112. through hole; 112. first mounting base; 1121. first articulated head; 12. first driving assembly; 121. first driving motor; 122. first eccentric connecting member; 1221. connecting shaft; 1222. eccentric head; 13. first swinging member; 131. first connecting rod; 1311. first rotating shaft hole; 132. first swinging tongue; 14. first rotating shaft; 20. second swinging mechanism; 21. second support member; 211. second fixing cavity; 212. second mounting base; 2121. second articulated head; 213. motor fixing cavity; 22. second driving assembly; 221. second driving motor; 222. second eccentric connecting member; 23. second swinging member; 231. second connecting rod; 2311. second rotating shaft hole; 232. first swinging ball; 24. second rotating shaft; 25. first vibration motor; 30. third swinging mechanism; 31. third support member; 311. third fixing cavity; 312. third mounting base; 3121. third articulated head; 32. third driving assembly; 321. third driving motor; 322. third eccentric connecting member; 33. third swinging member; 331. third connecting rod; 3311. third rotating shaft hole; 332. second swinging tongue; 333. second swinging ball; 34. third rotating shaft; 40. first adult massager; 41. first outer housing; 42. accommodating cavity; 421. swinging tongue cavity; 422. massaging member; 43. first circuit board; 44. second vibration motor; 45. first battery; 46. first button; 47. first charging pin; 50. second adult massager; 51. inner housing; 52. second circuit board; 53. second battery; 54. second button; 55. second charging pin; 56. second outer housing; 561. outer housing main body; 5611. swinging ball cavity; 562. sealing cover body.

### DETAILED DESCRIPTION OF THE EMBODIMENTS

To make the purposes, technical solutions, and advantages of the embodiments of the present invention clearer, the following clearly and completely describes the technical solutions in the embodiments of the present invention with reference to the accompanying drawings in the embodiments of the present invention. Apparently, the described embodiments are some but not all of the embodiments of the present invention. Assemblies of the embodiments of the present invention described and shown in the accompanying drawings can be arranged and designed in various different configurations.

Therefore, the detailed description of the embodiments of the present invention provided in the accompanying drawings is not intended to limit the claimed protection scope of the present invention, but only to represent selected embodiments of the present invention. Based on the embodiments in the present invention, all other embodiments obtained by those of ordinary skill in the art without creative effects shall fall within the protection scope of the present invention.

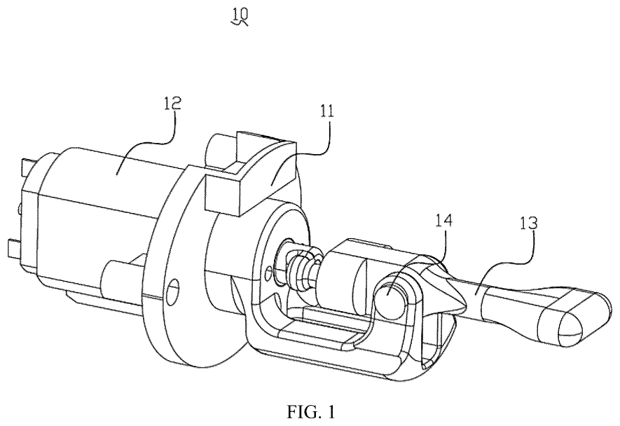

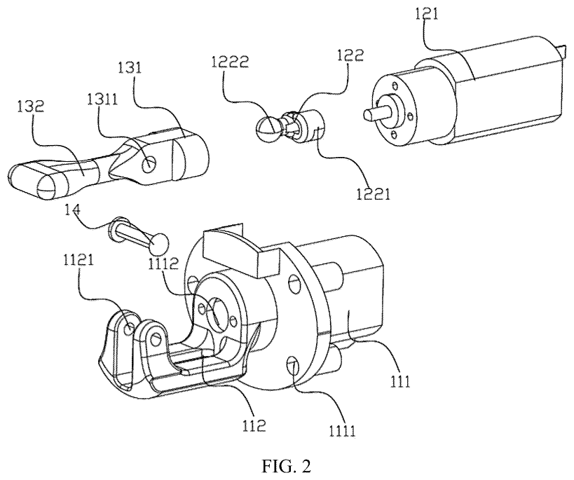

Referring to FIG. 1 and FIG. 2, in an embodiment, a first swinging mechanism 10 is applied to an adult massager and includes a first support member 11, a first driving assembly 12, a first swinging member 13, and a first rotating shaft 14. The first support member 11 is a support main body. The first driving assembly 12 is disposed on the first support member 11. The first swinging member 13 is rotatably disposed on the first support member 11 through the first rotating shaft 14 and is in transmission connection with the first driving assembly 12. The first driving assembly 12 drives the first swinging member 13 to perform a swinging operation on the first support member 11.

Referring to FIG. 1 and FIG. 2, in the embodiment, the first support member 11 includes a first fixing cavity 111 and a first mounting base 112 that are fixedly connected. The first driving assembly 12 is movably disposed on the first fixing cavity 111 in a penetrating manner, and the first swinging member 13 is rotatably disposed on the first mounting base 112 through the first rotating shaft 14 and is in transmission connection with the first driving assembly 12. Specifically, the first fixing cavity 111 is provided with a plurality of fixing holes 1111 in a penetrating manner, and the first support member 11 is fixedly mounted in the adult massager through the plurality of fixing holes 1111. The first fixing cavity 111 is provided with a through hole 1112 in a penetrating manner, and the first driving assembly 12 movably penetrates through the first fixing cavity 111 through the through hole 1112. A first articulated head 1121 is disposed on the first mounting base 112, and the first swinging member 13 is rotatably disposed on the first articulated head 1121 through the first rotating shaft 14.

Referring to FIG. 1 and FIG. 2, in the embodiment, the first driving assembly 12 includes a first driving motor 121 and a first eccentric connecting member 122. The first driving motor 121 is fixedly disposed in the first fixing cavity 111, and an output shaft of the first driving motor movably penetrates through the first fixing cavity 111 through the through hole 1112. One end of the first eccentric connecting member 122 is in transmission connection with the first driving motor 121, and the other end of the first eccentric connecting member is in transmission connection with the first swinging member 13. The first driving motor 121 drives the first swinging member 13 through the first eccentric connecting member 122 to perform a longitudinal swinging operation. Specifically, the first eccentric connecting member 122 includes a connecting shaft 1221 and an eccentric head 1222. The connecting shaft 1221 is fixedly connected to the output shaft of the first driving motor 121. The eccentric head 1222 is eccentrically and fixedly disposed on one side of the connecting shaft 1221 and is in transmission connection with the first swinging member 13, and the first driving motor 121 drives the first swinging member 13 through the connecting shaft 1221 and the eccentric head 1222 in sequence to perform the longitudinal swinging operation.

Referring to FIG. 1 and FIG. 2, in the embodiment, the first swinging member 13 includes a first connecting rod 131 and a first swinging tongue 132. The first connecting rod 131 is in transmission connection with the eccentric head 1222 and is movably disposed on the first articulated head 1121 through the first rotating shaft 14. The first swinging tongue 132 is fixedly disposed on one side of the first connecting rod 131 and is on the same straight line as the first connecting rod 131, and the first driving motor 121 drives the first swinging tongue 132 through the connecting shaft 1221, the eccentric head 1222, and the first connecting rod 131 in sequence to perform the longitudinal swinging operation. In another embodiment, the first swinging tongue 132 and the first connecting rod 131 may also be disposed at a certain angle. Specifically, the first connecting rod 131 is provided with a first rotating shaft hole 1311 in a penetrating manner, and the first rotating shaft 14 movably penetrates through the first rotating shaft hole 1311 to be disposed on the first articulated head 1121, so that the first swinging tongue 132 performs the longitudinal swinging operation through the first rotating shaft 14.

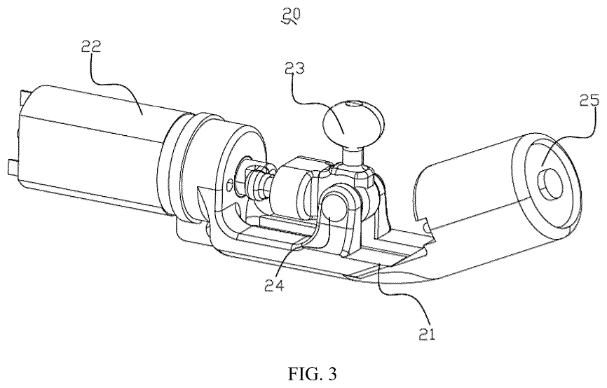

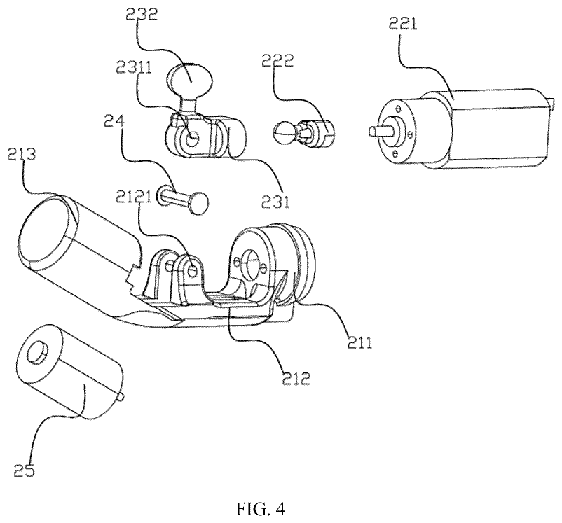

Referring to FIG. 3 and FIG. 4, in an embodiment, a second swinging mechanism 20 is applied to an adult massager and includes a second support member 21, a second driving assembly 22, a second swinging member 23, a second rotating shaft 24, and a first vibration motor 25. The second support member 21 is a support main body. The second driving assembly 22 is disposed on the second support member 21. The second swinging member 23 is rotatably disposed on the second support member 21 through the second rotating shaft 24 and is in transmission connection with the second driving assembly 22, and the second driving assembly 22 drives the second swinging member 23 to perform a swinging operation on the second support member 21. The first vibration motor 25 is fixedly disposed on the second support member 21 and can drive the second support member 21 to perform a vibration operation.

Referring to FIG. 3 and FIG. 4, in the embodiment, the second support member 21 includes a second fixing cavity 211, a second mounting base 212, and a motor fixing cavity 213 that are sequentially connected. The second driving assembly 22 is movably disposed on the second fixing cavity 211 in a penetrating manner, the second swinging member 23 is rotatably disposed on the second mounting base 212 through the second rotating shaft 24 and is in transmission connection with the second driving assembly 22, and the first vibration motor 25 is fixedly disposed in the motor fixing cavity 213. Specifically, a second articulated head 2121 is disposed on the second mounting base 212, and the second swinging member 23 is rotatably disposed on the second articulated head 2121 through the second rotating shaft 24.

Referring to FIG. 3 and FIG. 4, in the embodiment, the second driving assembly 22 includes a second driving motor 221 and a second eccentric connecting member 222. The second driving motor 221 is fixedly disposed in the second fixing cavity 211, and an output shaft of the second driving motor movably penetrates through the second fixing cavity 211. One end of the second eccentric connecting member 222 is in transmission connection with the second driving motor 221, and the other end of the second eccentric connecting member is in transmission connection with the second swinging member 23. The second driving motor 221 drives the second swinging member 23 through the second eccentric connecting member 222 to perform a longitudinal swinging operation. Specifically, a structure of the second eccentric connecting member 222 is similar to that of the first eccentric connecting member 122, and therefore, a specific structure of the second eccentric connecting member is not described in detail herein.

Referring to FIG. 3 and FIG. 4, in the embodiment, the second swinging member 23 includes a second connecting rod 231 and a first swinging ball 232. The second connecting rod 231 is in transmission connection with the second eccentric connecting member 222 and is movably disposed on the second articulated head 2121 through the second rotating shaft 24. The first swinging ball 232 is fixedly disposed on the second connecting rod 231 and is disposed perpendicular to the second connecting rod 231, and the second driving motor 221 drives the first swinging ball 232 through the second eccentric connecting member 222 and the second connecting rod 231 in sequence to perform a transverse swinging operation. In another embodiment, the first swinging ball 232 and the second connecting rod 231 may also be disposed at a certain angle. Specifically, the second connecting rod 231 is provided with a second rotating shaft hole 2311 in a penetrating manner, and the second rotating shaft 24 movably penetrates through the second rotating shaft hole 2311 to be disposed on the second articulated head 2121, so that the first swinging ball 232 performs the transverse swinging operation through the second rotating shaft 24.

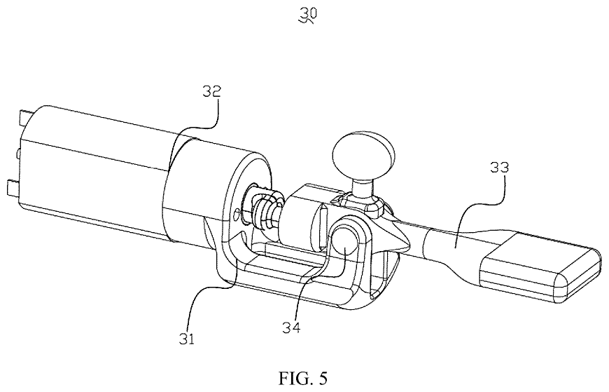

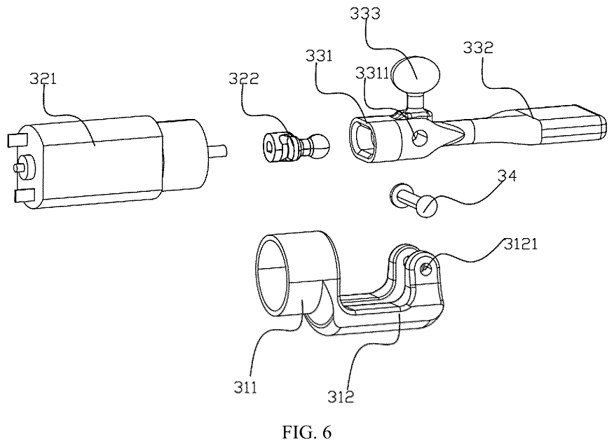

Referring to FIG. 5 and FIG. 6, in an embodiment, a third swinging mechanism 30 is applied to an adult massager and includes a third support member 31, a third driving assembly 32, a third swinging member 33, and a third rotating shaft 34. The third support member 31 is a support main body. The third driving assembly 32 is disposed on the third support member 31. The third swinging member 33 is rotatably disposed on the third support member 31 through the third rotating shaft 34 and is in transmission connection with the third driving assembly 32. The third driving assembly 32 drives the third swinging member 33 to perform a swinging operation on the third support member 31.

Referring to FIG. 5 and FIG. 6, in the embodiment, the third support member 31 includes a third fixing cavity 311 and a third mounting base 312 that are sequentially and fixedly connected. The third driving assembly 32 is movably disposed on the third fixing cavity 311 in a penetrating manner, and the third swinging member 33 is rotatably disposed on the third mounting base 312 through the third rotating shaft 34 and is in transmission connection with the third driving assembly 32. Specifically, a third articulated head 3121 is disposed on the third mounting base 312, and the third swinging member 33 is rotatably disposed on the third articulated head 3121 through the third rotating shaft 34.

Referring to FIG. 5 and FIG. 6, in the embodiment, the third driving assembly 32 includes a third driving motor 321 and a third eccentric connecting member 322. The third driving motor 321 is fixedly disposed in the third fixing cavity 311, and an output shaft of the third driving motor movably penetrates through the third fixing cavity 311. One end of the third eccentric connecting member 322 is in transmission connection with the third driving motor 321, and the other end of the third eccentric connecting member is in transmission connection with the third swinging member 33. The third driving motor 321 drives the third swinging member 33 through the third eccentric connecting member 322 to perform longitudinal and transverse swinging operations simultaneously. Specifically, a structure of the third eccentric connecting member 322 is similar to that of the first eccentric connecting member 122, and therefore, a specific structure of the third eccentric connecting member is not described in detail herein.

Referring to FIG. 5 and FIG. 6, in the embodiment, the third swinging member 33 includes a third connecting rod 331, a second swinging tongue 332, and a second swinging ball 333. The third connecting rod 331 is in transmission connection with the third eccentric connecting member 322 and is movably disposed on the third articulated head 3121 through the third rotating shaft 34. The second swinging tongue 332 is fixedly disposed on one side of the third connecting rod 331 and is on the same straight line as the third connecting rod 331. The second swinging ball 333 is fixedly disposed on the third connecting rod 331 and is disposed perpendicular to the third connecting rod 331, and the third driving motor 321 synchronously drives the second swinging tongue 332 and the second swinging ball 333 through the third eccentric connecting member 322 and the third connecting rod 331 in sequence to perform longitudinal swinging and transverse swinging respectively. Specifically, the third connecting rod 331 is provided with a third rotating shaft hole 3311 in a penetrating manner, and the third rotating shaft 34 movably penetrates through the third rotating shaft hole 3311 to be disposed on the third articulated head 3121.

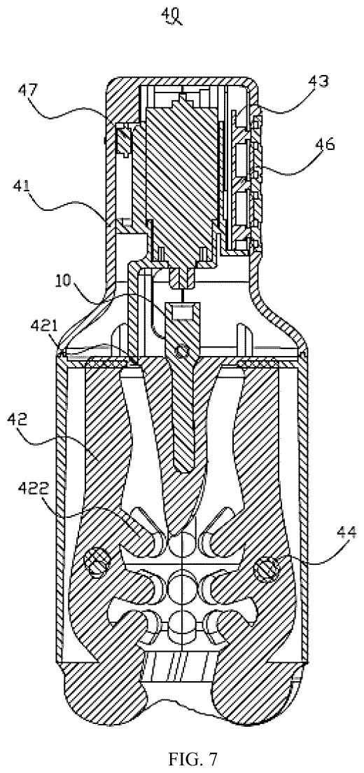

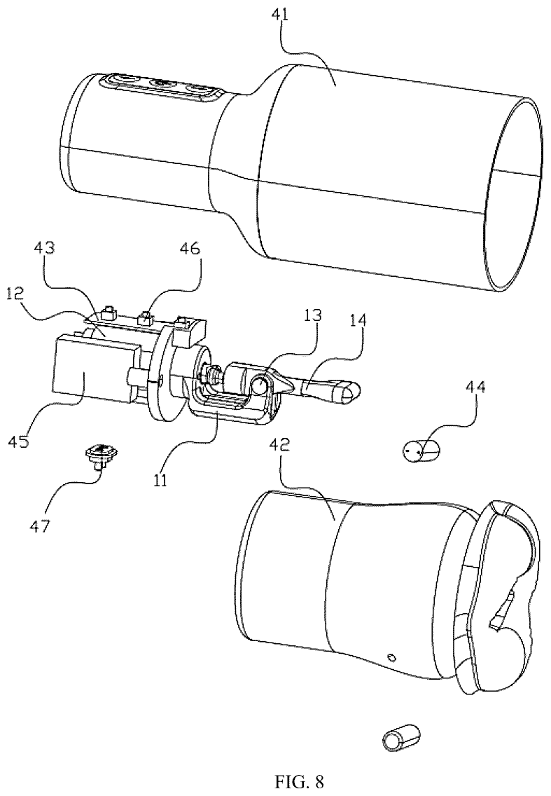

Referring to FIG. 7 and FIG. 8, a first adult massager 40 includes a first outer housing 41, an accommodating cavity 42, a first circuit board 43, at least one second vibration motor 44, a first battery 45, a plurality of first buttons 46, a first charging pin 47, and a first swinging mechanism 10. The first outer housing 41 is a hollow cavity with an opening at one end. The accommodating cavity 42 is made of a flexible material and is fixedly disposed in the first outer housing 41, and an opening direction of the accommodating cavity is consistent with an opening direction of the first outer housing 41. The first circuit board 43 and the first battery 45 are fixedly mounted in the first outer housing 41 respectively, the first circuit board 43 is electrically connected to the at least one second vibration motor 44, the first battery 45, the plurality of first buttons 46, the first charging pin 47, and the first swinging mechanism 10 respectively, and the first battery 45 supplies electric energy to the first circuit board 43, the at least one second vibration motor 44, and the first swinging mechanism 10 respectively. The at least one second vibration motor 44 is fixedly disposed in the accommodating cavity 42 and drives the accommodating cavity 42 to perform a vibration operation. The plurality of first buttons 46 are disposed on the first circuit board 43 respectively and penetrate through the first outer housing 41 respectively, and switching-on/off or functional setting of the first adult massager 40 is controlled through a corresponding first button 46. The first charging pin 47 is fixedly disposed in the first outer housing 41 in a penetrating manner, and the first battery 45 is charged through the first charging pin 47. The first swinging mechanism 10 is disposed in the first outer housing 41 and extends into the accommodating cavity 42, and the first swinging mechanism can perform a longitudinal swinging operation in the accommodating cavity 42. In the embodiment, two second vibration motors 44 are fixedly disposed on two opposite sides of the accommodating cavity 42 respectively, and the accommodating cavity 42 is driven to vibrate through the two second vibration motors 44. In another embodiment, one second vibration motor 44, three second vibration motors, or another quantity of second vibration motors may be disposed, and the quantity of the second vibration motors is set according to an actual requirement.

Referring to FIG. 7 and FIG. 8, in the embodiment, the first swinging mechanism 10 includes a first support member 11, a first driving assembly 12, a first swinging member 13, and a first rotating shaft 14. The first support member 11 is fixedly mounted in the first outer housing 41. The first driving assembly 12 is disposed on the first support member 11 and is electrically connected to the first circuit board 43. The first swinging member 13 is rotatably disposed on the first support member 11 through the first rotating shaft 14 and is in transmission connection with the first driving assembly 12, and the first swinging member extends into a swinging tongue cavity 421 of the accommodating cavity 42, thereby performing a swinging massaging operation on a front end of a male genital organ extending into the accommodating cavity 42. Specifically, a plurality of massaging members 422 are disposed on an inner wall of the accommodating cavity 42 in an integrally-formed manner, and the massaging operation is performed on the male genital organ extending into the accommodating cavity 42 through the plurality of massaging members 422.

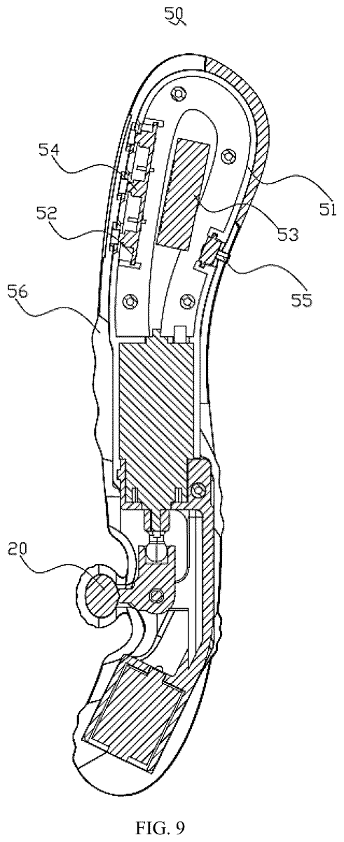

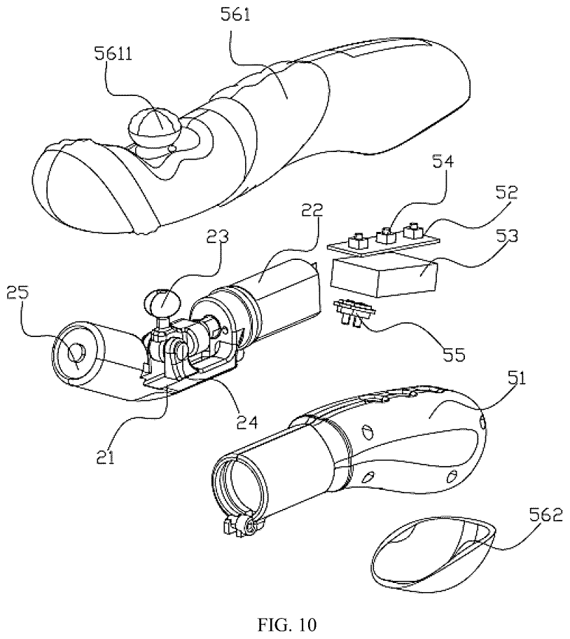

Referring to FIG. 9 and FIG. 10, in an embodiment, a second adult massager 50 includes an inner housing 51, a second circuit board 52, a second battery 53, a plurality of second buttons 54, a second charging pin 55, a second outer housing 56, and a second swinging mechanism 20. The inner housing 51 is a hollow cavity with an opening at one end and is a support main body. The second circuit board 52 and the second battery 53 are fixedly mounted in the inner housing 51 respectively, the second circuit board 52 is electrically connected to the second battery 53, the plurality of second buttons 54, the second charging pin 55, and the second swinging mechanism 20 respectively, and the second battery 53 supplies electric energy to the second circuit board 52 and the second swinging mechanism 20 respectively. The plurality of second buttons 54 are disposed on the second circuit board 52 respectively and penetrate through the inner housing 51 respectively, and switching-on/off or functional setting of the second adult massager 50 is controlled through a corresponding second button 54. The second charging pin 55 sequentially penetrates through the inner housing 51 and the second outer housing 56 to be electrically connected to the second circuit board 52, and the second battery 53 is charged through the second charging pin 55. One end of the second swinging mechanism 20 is fixedly disposed on the inner housing 51. The second outer housing 56 is made of a flexible material and wraps the inner housing 51 and the second swinging mechanism 20 respectively. The second swinging mechanism 20 drives the second outer housing 56 to perform a transverse swinging operation.

Referring to FIG. 9 and FIG. 10, in the embodiment, the second outer housing 56 includes an outer housing main body 561 and a sealing cover body 562. The outer housing main body 561 is a hollow flexible sleeve body with an opening at one end, and the inner housing 51 and the second swinging mechanism 20 are disposed in the outer housing main body 561 respectively. The sealing cover body 562 is detachably connected at the opening of the outer housing main body 561 in a sealing manner, thereby enhancing sealing performance of the outer housing main body 561. Specifically, the outer housing main body 561 is vertically provided with a protruding swinging ball cavity 5611, and the swinging ball cavity 5611 is integrally formed with the outer housing main body 561.

Referring to FIG. 9 and FIG. 10, in the embodiment, the second swinging mechanism 20 includes a second support member 21, a second driving assembly 22, a second swinging member 23, a second rotating shaft 24, and a first vibration motor 25. One end of the second support member 21 is fixedly disposed on the inner housing 51. The second driving assembly 22 is disposed on the second support member 21. The second swinging member 23 is rotatably disposed on the second support member 21 through the second rotating shaft 24 and is in transmission connection with the second driving assembly 22, and the second swinging member extends into the swinging ball cavity 5611 on the outer housing main body 561, thereby performing a swinging massaging operation on an inner wall of a female genital organ. The first vibration motor 25 is fixedly disposed at a front end of the second support member 21 and can drive the second support member 21 to perform a vibration operation, thereby performing a vibration massaging operation on the female genital organ.

The technical features of the above embodiments can be combined in any way. To simplify the description, not all possible combinations of the technical features in the embodiments are described. However, as long as there is no contradiction in the combinations of these technical features, all possible combinations should be considered to fall within the scope of the specification.

The above embodiments only represent several implementation manners of the present invention, and the description thereof is relatively specific and detailed but should not be construed as limiting the scope of the present invention. It should be noted that for those of ordinary skill in the art, several modifications and improvements can be made without departing from the concept of the present invention and these modifications and improvements should all fall within the protection scope of the present invention. Therefore, the protection scope of the present invention shall be subject to the appended claims.

What is claimed is:

1. A swinging mechanism, applied to an adult massager, comprising:
a support member;
a driving assembly, disposed on the support member; and
a swinging member, rotatably disposed on the support member through a rotating shaft and being in transmission connection with the driving assembly, wherein
the driving assembly drives the swinging member to perform a longitudinal or transverse swinging operation on the support member.

2. The swinging mechanism according to claim 1, wherein the support member comprises a fixing cavity and a mounting base that are fixedly connected; the driving assembly is movably disposed on the fixing cavity in a penetrating manner; and the swinging member is rotatably disposed on the mounting base through the rotating shaft and is in transmission connection with the driving assembly.

3. The swinging mechanism according to claim 2, wherein the fixing cavity is provided with a plurality of fixing holes in a penetrating manner, and the support member is fixedly mounted in the adult massager through the plurality of fixing holes.

4. The swinging mechanism according to claim 2, wherein the fixing cavity is provided with a through hole in a penetrating manner, and the driving assembly movably penetrates through the fixing cavity through the through hole.

5. The swinging mechanism according to claim 2, wherein an articulated head is disposed on the mounting base, and the swinging member is rotatably disposed on the articulated head through the rotating shaft.

6. The swinging mechanism according to claim 2, wherein the driving assembly comprises a driving motor and an eccentric connecting member that are in transmission connection; the driving motor is fixedly disposed in the fixing cavity, and an output shaft of the driving motor movably penetrates through the fixing cavity; and two ends of the eccentric connecting member are in transmission connection with the driving motor and the swinging member respectively.

7. The swinging mechanism according to claim 6, wherein the eccentric connecting member comprises a connecting shaft and an eccentric head; the connecting shaft is fixedly connected to the output shaft of the driving motor; and the eccentric head is eccentrically and fixedly disposed on one side of the connecting shaft and is in transmission connection with the swinging member.

8. The swinging mechanism according to claim 6, wherein the swinging member comprises a connecting rod and a swinging tongue; the connecting rod is in transmission connection with the eccentric connecting member; and the swinging tongue is fixedly disposed on one side of the connecting rod and is on a same straight line as the connecting rod.

9. The swinging mechanism according to claim 6, wherein the swinging member comprises a connecting rod and a swinging ball; the connecting rod is in transmission connection with the eccentric connecting member; and the swinging ball is fixedly disposed on the connecting rod and is disposed perpendicular to the connecting rod.

10. The swinging mechanism according to claim 6, wherein the swinging member comprises a connecting rod, a swinging tongue, and a swinging ball; the connecting rod is in transmission connection with the eccentric connecting member; the swinging tongue is fixedly disposed on one side of the connecting rod and is on a same straight line as the connecting rod; and the swinging ball is fixedly disposed on the connecting rod and is disposed perpendicular to the connecting rod.

11. The swinging mechanism according to claim 1, wherein the swinging mechanism further comprises a vibration motor, and the vibration motor is fixedly disposed on the support member.

12. The swinging mechanism according to claim 11, wherein the support member comprises a fixing cavity, a mounting base, and a motor fixing cavity that are sequentially connected, the driving assembly is movably disposed on the fixing cavity in a penetrating manner, the swinging member is rotatably disposed on the mounting base through the rotating shaft and is in transmission connection with the driving assembly, and the vibration motor is fixedly disposed in the motor fixing cavity.

13. An adult massager, comprising:
an outer housing, being a hollow cavity with an opening at one end;
an accommodating cavity, made of a flexible material, wherein the accommodating cavity is fixedly disposed in the outer housing, and an opening direction of the accommodating cavity is consistent with an opening direction of the outer housing;
a circuit board, fixedly disposed in the outer housing;
at least one vibration motor, fixedly disposed in the accommodating cavity and electrically connected to the circuit board;
a plurality of buttons, disposed on the circuit board respectively and penetrating through the outer housing respectively;
a charging pin, fixedly disposed in the outer housing in a penetrating manner and electrically connected to the circuit board;
a swinging mechanism, disposed in the outer housing and extending into the accommodating cavity, wherein the swinging mechanism is electrically connected to the circuit board and can perform a longitudinal swinging operation in the accommodating cavity; and
a battery, fixedly mounted in the outer housing, wherein the battery supplies electric energy to the circuit board, the at least one vibration motor, and the swinging mechanism respectively.

14. The adult massager according to claim 13, wherein the swinging mechanism comprises: a support member, fixedly mounted in the outer housing; a driving assembly, disposed on the support member and electrically connected to the circuit board; and a swinging member, rotatably disposed on the support member through a rotating shaft, wherein the swinging member is in transmission connection with the driving assembly, and the swinging member extends into a swinging tongue cavity of the accommodating cavity.

15. The adult massager according to claim 13, wherein a plurality of massaging members are disposed on an inner wall of the accommodating cavity in an integrally-formed manner.

16. An adult massager, comprising:
an inner housing, being a hollow cavity with an opening at one end;
a circuit board, fixedly disposed in the inner housing;
a plurality of buttons, disposed on the circuit board respectively and penetrating through the inner housing respectively;
a charging pin, penetrating through the inner housing and electrically connected to the circuit board;
a swinging mechanism, wherein one end of the swinging mechanism is fixedly disposed on the inner housing;
a battery, fixedly mounted in the inner housing, wherein the battery supplies electric energy to the circuit board and the swinging mechanism respectively; and
an outer housing, made of a flexible material, wherein the outer housing wraps the inner housing and the swinging mechanism respectively, and the swinging mechanism drives the outer housing to perform a transverse swinging operation.

17. The adult massager according to claim 16, wherein the outer housing comprises: an outer housing main body, being a hollow flexible sleeve body with an opening at one end, wherein the inner housing and the swinging mechanism are disposed in the outer housing main body respectively; and a sealing cover body, detachably connected to the opening of the outer housing main body in a sealing manner.

18. The adult massager according to claim 17, wherein the outer housing main body is vertically provided with a protruding swinging ball cavity, and the swinging ball cavity is integrally formed with the outer housing main body.

19. The adult massager according to claim 18, wherein the swinging mechanism comprises: a support member, wherein one end of the support member is fixedly disposed on the inner housing; a driving assembly, disposed on the support member; a swinging member, rotatably disposed on the support member through a rotating shaft and being in transmission connection with the driving assembly, wherein the swinging member extends into the swinging ball cavity; and a vibration motor, fixedly disposed at a front end of the support member.

20. The adult massager according to claim 19, wherein the swinging member comprises a connecting rod and a swinging ball; the connecting rod is in transmission connection with the driving assembly; and the swinging ball is fixedly disposed on the connecting rod and is disposed perpendicular to the connecting rod.
